(19) United States
(12) Patent Application Publication
(10) Pub. No.: US 2019/0122526 A1
(43) Pub. Date: Apr. 25, 2019

(54) AUTOMATIC REMINDERS GENERATED THROUGH REAL TIME DATA

(71) Applicant: QUALCOMM Incorporated, San Diego, CA (US)

(72) Inventors: Hem AGNIHOTRI, Varanasi (IN); Bapineedu Chowdary GUMMADI, Hyderabad (IN); Venkata A Naidu BABBADI, Hyderabad (IN)

(21) Appl. No.: 15/791,100

(22) Filed: Oct. 23, 2017

(51) Int. Cl. G08B 21/24; G10L 15/22; G10L 15/16; G06F 17/27

(52) U.S. Cl. CPC G08B 21/24; G10L 15/22; G10L 2015/223; G06F 17/2705; G10L 15/16

(57) ABSTRACT

Disclosed are methods and apparatuses for automatically setting reminders for appointments and events. In an aspect, an apparatus engages in a communication, processes and parses a language in the communication, determines whether the language contains any setting of an appointment or event based on the processing and parsing of the language, and sets reminders based on the determination that the language contains an appointment or an event.

### FIELD

The present disclosure relates generally to mobile devices, and more particularly, to automatic reminders generated in mobile devices.

### BACKGROUND

Mobile devices have become integral part of the modern life. People use mobile devices to communicate and schedule their daily lives. In many cases, during active voice calls or voice messages, people often schedule many events such as meetings or events. In addition, mobile devices receive many reminder messages through the SMS messaging system such as appointments or bill payments etc. Unless the users of mobile devices actively create reminders for those appointments and events generated while using the mobile devices, the users can easily forget about the events or appointments that were generated while communicating through the mobile devices. Furthermore, some events could be recorded in notes that are stored in the mobile devices. Because of the busy schedules of many people who use mobile devices, people may easily forget about the events and appointments created while using the mobile devices. Therefore, there is a need for automatic setting of appointments and events while a mobile device is engaged in a communication.

### SUMMARY

The following presents a simplified summary of one or more aspects to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment or a mobile device including at least one processor and a memory coupled to the at least one processor. The processor engages in a communication, processes and parses a language in the communication, determines whether the language contains any setting of an appointment or event based on the processing and parsing of the language, and automatically sets reminders for the appointment or event based on the determination that the language contains an appointment or an event.

In an aspect, a method of automatically setting a reminder includes engaging in a communication, processing and parsing a language in the communication, determining whether the language contains any setting of an appointment or event based on the processing and parsing of the language, and automatically setting reminders for the appointment or event based on the determination that the language contains an appointment or an event.

In an aspect, an apparatus for automatically setting a reminder includes means for engaging in a communication, means for processing and parsing a language in the communication, means for determining whether the language contains any setting of an appointment or event based on the processing and parsing of the language, and means for automatically setting reminders for appointments and events based on the determination that the language contains an appointment or an event.

In an aspect, a non-transitory computer-readable medium storing computer-executable instructions for automatically setting a reminder includes computer-readable instructions comprising at least one instruction to engage in a communication, process and parse a language in the communication, determine whether the language contains any setting of an appointment or event based on the processing and parsing of the language, and automatically set reminders for the appointment or event based on the determination that the language contains an appointment or an event.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communication system and an access network.

FIG. 2 illustrates an example of processing a language in a conversation to automatically set a reminder according to an aspect.

FIG. 3A illustrates an example of processing a language in a text message to automatically set a reminder according to an aspect.

FIG. 3B illustrates an example of processing a language in a note to automatically set a reminder according to an aspect.

FIG. 4 illustrates an example implementation of designing a neural network using a system-on-chip (SOC), including a general purpose processor in accordance with an aspect.

FIG. 5 is a block diagram illustrating an examplary deep convolutional network (DCN) in accordance with an aspect.

FIG. 6 illustrates an examplary mobile device that may be suitably used in accordance with various aspects described herein.

FIG. 7 illustrates a flowchart of a method to automatically set reminders in accordance with various aspects.

FIG. 8 is a simplified block diagram of various aspects of an apparatus configured to support the functionalities disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of mobile devices will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

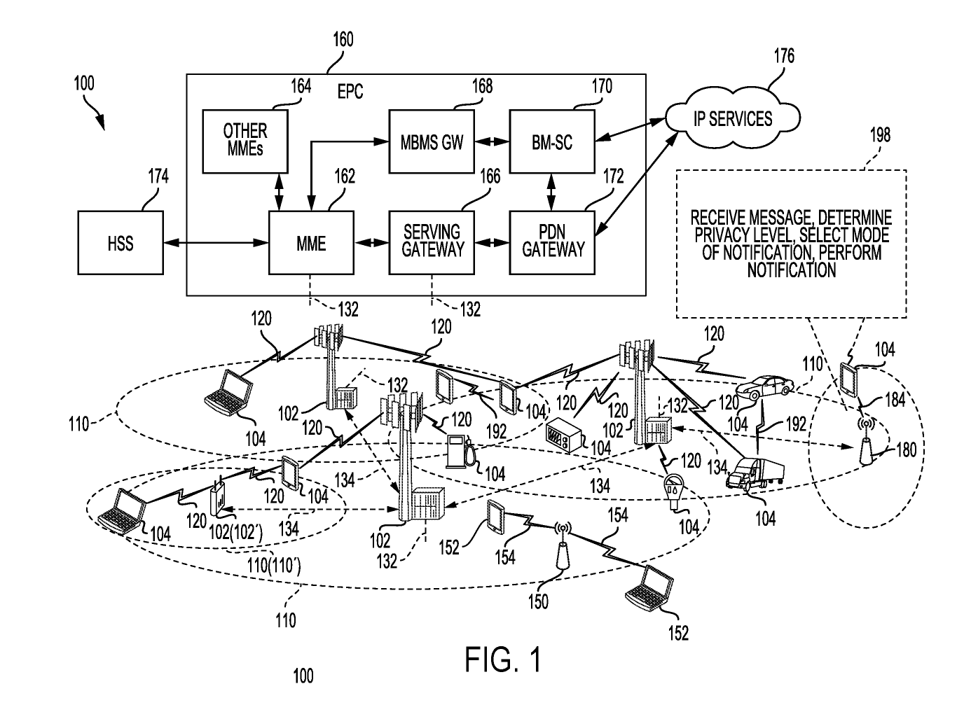

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ES S), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104/base station 180 may be configured to receive a message, determine a privacy level of the message, select a mode of notification of the message based on the determined privacy level of the message, and perform a notification action based on the selected mode of notification (198).

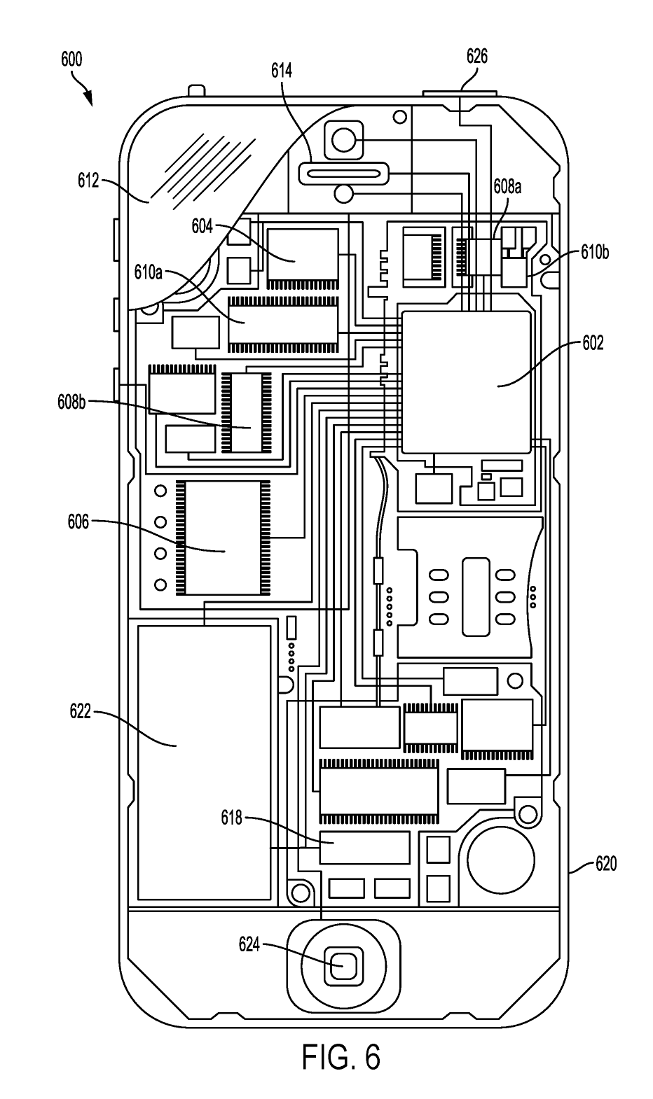

According to various aspects, FIG. 6 illustrates an exemplary mobile device or UE 600 suitable for use in accordance with the various aspects and embodiments described herein. The mobile device 600 may be one of the UEs 104 shown in FIG. 1. For example, in various embodiments, the mobile device 600 may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, a display of the mobile device need not have touchscreen capabilities.

The mobile device 600 may have one or more cellular network transceivers 608a, 608b coupled to the processor 602 and configured to send and receive cellular communications over one or more wireless networks. The transceivers 608a and 608b may be used with the above-mentioned circuitry to implement the various aspects and embodiment described herein.

In various embodiments, the mobile device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not explicitly shown in FIG. 6).

In various embodiments, the mobile device 600 may also include one or more speakers 614 to provide audio outputs. The mobile device 600 may also include a housing 620, which may be constructed of a plastic, metal, or a combination of materials, to contain all or one or more of the components discussed herein. The mobile device 600 may include a power source 622 coupled to the processor 602, such as a disposable or rechargeable battery. The rechargeable battery 622 may also be coupled to the peripheral device connection port (not shown) to receive a charging current from a source external to the mobile device 600. The mobile device 600 may also include a physical button 624 configured to receive user inputs and a power button 626 configured to turn the mobile device 600 on and off

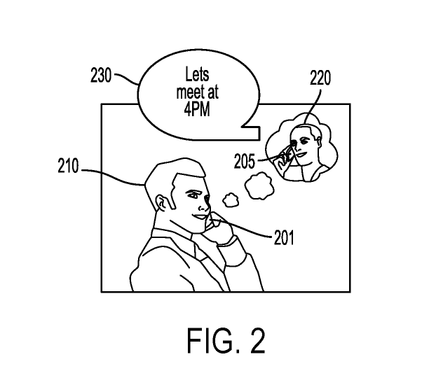

FIG. 2 illustrates a situation where a caller 210 and a caller 220 are engaged in a conversation using mobile devices 201 and 205 over a network such as the access network 100 shown in FIG. 1. The mobile devices 201 and 205 maybe similar or same as the mobile device 600. During the conversation, the callers 210 and 220 decides to have a meeting at 4 PM as shown in 230. In an aspect, during the conversation, the mobile devices 201 and 205 process the conversation between the callers 210 and 220 and parse the conversational language between the callers 210 and 220 to find any setting of appointments or events so that the mobile devices 201 and 205 may automatically set reminders without any interaction from the callers 210 and 220. The reminders may be set using any type of reminder apps on the mobile devices 201 and 205 such as a calendar app. As shown in FIG. 2, the mobile devices 201 and 205 will automatically set reminders for the 4 PM meeting on its respective mobile device. The callers 210 and 220 may decide whether to allow the mobile devices 201 and 205 to set reminders automatically based on their conversation. If the callers 210 and 220 set their respective phones to not allow automatic setting of reminders, the mobile devices 201 and 205 will not set any automatic reminders.

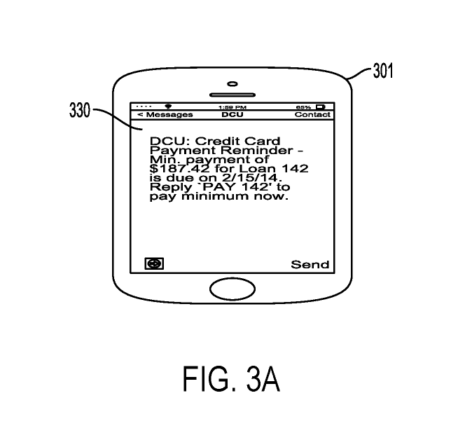

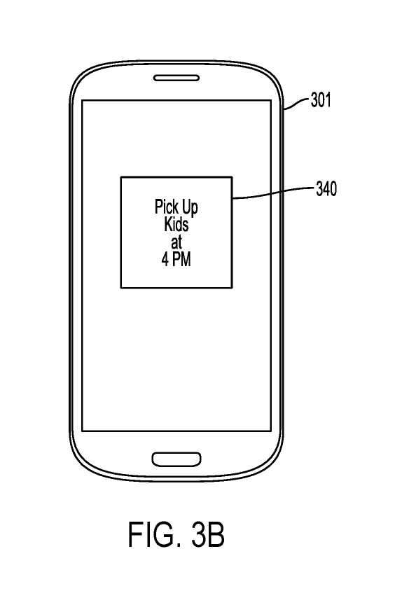

FIG. 3A illustrates a situation where the mobile device 301 receives a text message. The mobile device 301 processes and parses the language in the text message to set automatic reminders. As shown in FIG. 3A, based on the language, the mobile device 301 will set a reminder for a credit card payment. FIG. 3B illustrates a note made by a user of the mobile device 301. The note is stored on the mobile device 301 by the user. As soon as the note is saved on the mobile device 301, the mobile device 301 processes and parses the language in the note and sets an automatic reminder on the mobile device 301. However, in an aspect, the processing and parsing of a communication language is not limited to a call conversation, a note or a text message. Any type of communication that the mobile device 600 or other similar devices engage in can be processed and parsed to determine if there are any setting of appointments or events. Thus, any communication through the network 100 may be processed and parsed to detect setting of appointments and events to automatically set reminders for those appointments and events.

The mobile devices 201, 205 and 301 may send the reminder alerts to their own users and to other parties of the appointments with appropriate permissions. The mobile devices 201, 205 and 301 may alert the users of their appointments or events by using various means such as pop up windows, ring tones, vibrations, etc. The mobile devices 201, 205 and 301 also may send alerts to devices owned by other parties to the appointments or events when the devices are given appropriate permissions. For example, the mobile device 301 may send an alert about an appointment or event to the mobile device 205 if the mobile device 301 was given the appropriate permission.

Furthermore, the mobile device 201, 205 and 301 may send alerts to other devices that are connected to the mobile devices in an “Internet of Things device” (IoT) network. Such IoT devices may refer to any object (e.g., an appliance, a sensor, etc.) that has an addressable interface (e.g., an Internet protocol (IP) address, a Bluetooth® identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, a near-field communication (NFC) tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, application-specific integrated circuit (ASIC), or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

For example, if the user of the mobile device 301 is not near the mobile device 301, the mobile device 301 may send an alert to another IoT device near the user. However, the user needs to give permission to the mobile device 301 to send an alert to another IoT device.

Referring to FIG. 6, the processing and the parsing of the language used during a conversation, a text message or a note may be performed by the processor 602 that functions as a speech and language processor. Furthermore, the language processing and parsing may be performed by an artificial neural network that resides in the processor 602 or in another part of the mobile device 600. The artificial neural network may reside outside the mobile device 600 and maybe part of the access network 100. An artificial neural network is particularly suited for the language processing because a neural network may be trained to recognize the language patterns of a caller using a mobile device and can easily adapt to recognize any setting of appointments and events during a conversation.

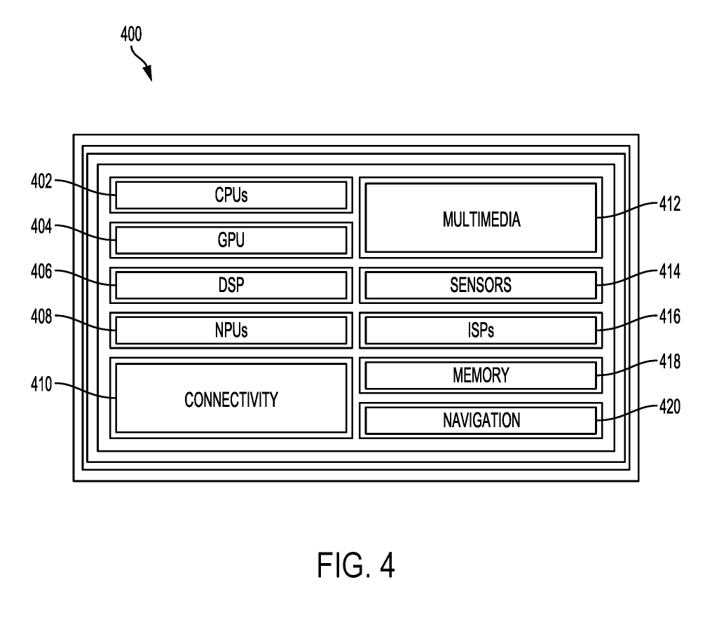

An artificial neural network for language processing and parsing may be implemented using a system-on-a-chip (SOC) 400 shown in FIG. 4, which may include a general-purpose processor (CPU) or multi-core general-purpose processors (CPUs) 402 in accordance with certain aspects of the present disclosure. The SOC 400 may include the processor 602 or other parts of the mobile device 600. The SOC 400 may reside in the processor 602. Variables (e.g., neural signals and synaptic weights), system parameters associated with a computational device (e.g., neural network with weights), delays, frequency bin information, and task information may be stored in a memory block associated with a neural processing unit (NPU) 408, in a memory block associated with a CPU 402, in a memory block associated with a graphics processing unit (GPU) 404, in a memory block associated with a digital signal processor (DSP) 406, in a dedicated memory block 418, or may be distributed across multiple blocks. Instructions executed at the general-purpose processor 402 may be loaded from a program memory associated with the CPU 402 or may be loaded from a dedicated memory block 418.

The SOC 400 may also include additional processing blocks tailored to specific functions, such as a GPU 404, a DSP 406, a connectivity block 410, which may include fourth generation long term evolution (4G LTE) connectivity, unlicensed Wi-Fi connectivity, USB connectivity, Bluetooth connectivity, and the like, and a multimedia processor 412 that may, for example, detect and recognize gestures. In one implementation, the NPU is implemented in the CPU, DSP, and/or GPU. The SOC 400 may also include a sensor processor 414, image signal processors (ISPs) 416, and/or navigation 420, which may include a global positioning system.

The SOC 400 may be based on an ARM instruction set. In an aspect of the present disclosure, the instructions loaded into the general-purpose processor 402 may comprise code to draw, at the behavior generator, a vector from a probability distribution obtained from behavior data of multiple users. The instructions loaded into the general-purpose processor 402 may also comprise code to generate, with an artificial neural network decoder of the behavior generator, a synthetic behavior sample based on the vector. The instructions loaded into the general-purpose processor 402 may further comprise code to tune a model, which identifies a device user, using the generated synthetic behavior sample.

In another aspect of the present disclosure, the instructions loaded into the general-purpose processor 402 may comprise code to train a convolutional auto encoder of the artificial neural network to generate a representation of an original behavior sample received from behavior data of multiple users. The instructions loaded into the general-purpose processor 402 may also comprise code to estimate, after training the convolutional auto encoder, a per-user distribution and a distribution of all users of the multiple users for each original behavior sample of the behavior data. The instructions loaded into the general-purpose processor 402 may further comprise code to combine the distribution of all users to determine a probability distribution of the behavior data.

Aspects of the present disclosure are not limited to the general-purpose processor 402 performing the aforementioned functions. The code may also be executed by the CPU, DSP, GPU, and/or any other type of processor.

In an aspect, a neural network implemented by the SOC 400 may be a deep convolutional network. A deep convolutional network is particularly well suited for language processing and parsing for its robustness and ability to efficiently train its network to adapt to the language pattern of its user. However, the SOC 400 is not limited to a deep convolutional network but may implement other types of neural network such as a recurrent neural network or spiking neural network. A recurrent neural network is also well suited for language processing.

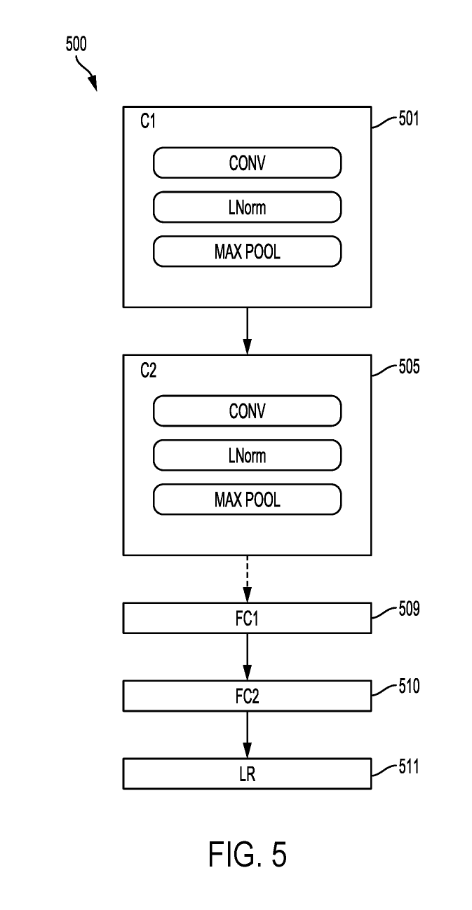

FIG. 5 is a block diagram illustrating an exemplary deep convolutional network 500. The deep convolutional network 500 may include multiple different types of layers based on connectivity and weight sharing. As shown in FIG. 5, the exemplary deep convolutional network 500 includes multiple convolution blocks 501 and 505 (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 500 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 402 or GPU 404 of the SOC 400, optionally based on an ARM instruction set, to achieve high performance and low power consumption. In alternative embodiments, the parallel filter banks may be loaded on the DSP 406 or an ISP 416 of the SOC 400. In addition, the DCN may access other processing blocks that may be present on the SOC, such as processing blocks dedicated to sensors 414 and navigation 420.

The deep convolutional network 500 may also include one or more fully connected layers 509 and 510 (e.g., FC1 and FC2). The deep convolutional network 500 may further include a logistic regression (LR) layer 511. The deep convolutional network 500 may also use batch normalization layers, shortcuts between layers, and splits in a network graph. Between each layer of the deep convolutional network 500 are weights (not shown) that are to be updated. The output of each layer may serve as an input of a succeeding layer in the deep convolutional network 500 to learn hierarchical feature representations from input data (e.g., images, audio, video, sensor data and/or other input data) supplied at the first convolution block 501.

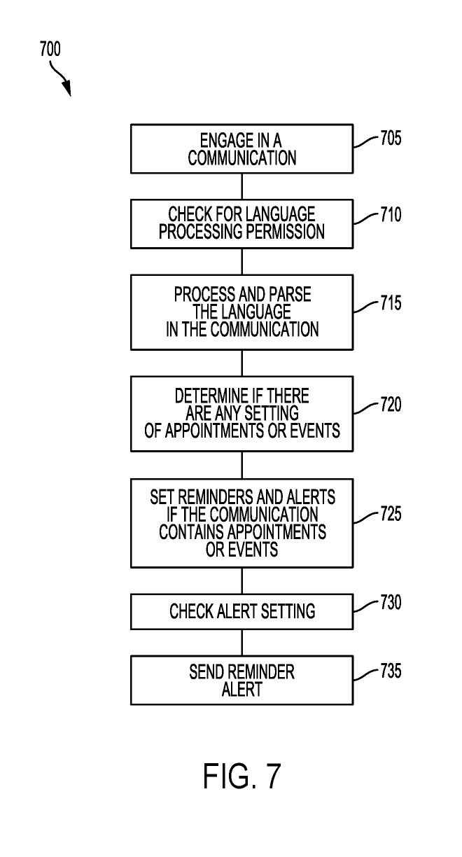

FIG. 7 is a flowchart 700 of a method of automatically setting reminders based on processing and parsing the language communicated through a mobile device, according to an aspect. The method may be performed by a processor. In one configuration, the flowchart 700 described in FIG. 7 may be performed by the mobile device 600 described above with reference to FIG. 6.

In an aspect, at 705, the mobile device 600 engages in a communication. The communication may be a verbal communication, a text message, a note, an email or any type of communication over the network 100. At 710, the mobile device 600 checks to see if the mobile device 600 has a permission from the user to process and parse the language of the communication to detect any setting of appointments and events. If the mobile device 600 has the permission, then the mobile device 600 will proceed to 715.

At 715, the processor 602 processes and parses the language of the communication. The processor 602 may contain a neural network to process and parse the language. The neural network may be located in another SOC in communication with the processor 602. At 720, the processor 720 detects and determines if the language contains any setting of appointments or events. At 725, the processor 602 automatically sets reminders and alerts for the appointments and events if the language of the communication contains any setting of appointments and alerts. The processor 602 uses various apps to set reminders. At 730, the processor 602 checks the alert setting for the reminders. Based on the alert setting, the processor 602 alerts the user using various methods such as pop up windows, vibrations, text messages, ringing, etc. Also, based on the alert setting, the mobile device 600 may send alerts to other devices controlled by other participating parties of the appointments and events. Furthermore, the mobile device 600 may send alerts to other devices of other participating parties only if the mobile device 600 is given an appropriate permission by the other parties.

At 735, the mobile device 600 sends out the alerts for the reminders. As mentioned above, the alerts may be sent to other devices that are connected to the mobile device 600 in an IoT network.

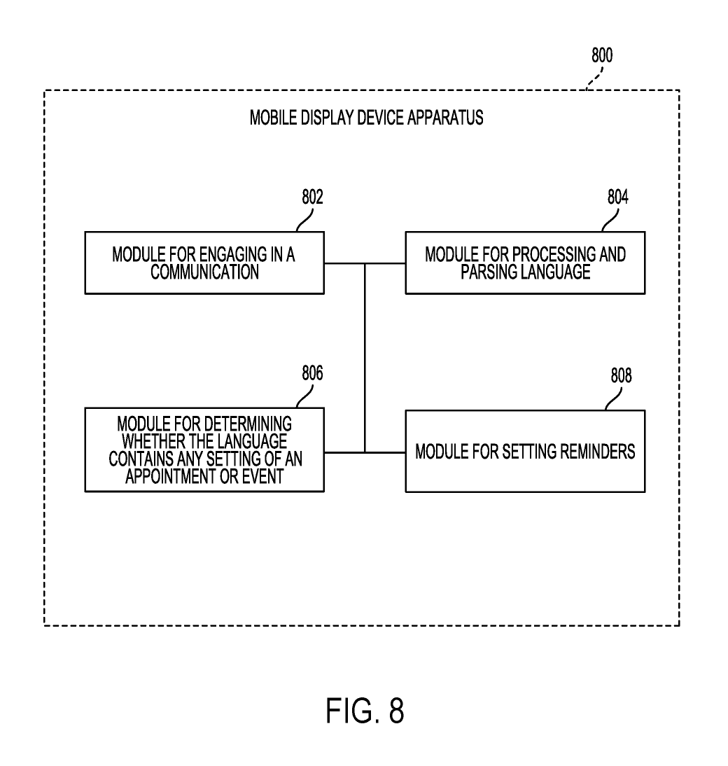

FIG. 8 illustrates an example mobile device apparatus 800 (which may correspond to the mobile device 600) represented as a series of interrelated functional modules. A module for engaging in a communication 802 may correspond at least in some aspects to, for example, a processing system, such as processor 602, in conjunction with a storage device, such as memory 606, as discussed herein. A module for processing and parsing language 804 may correspond at least in some aspects to, for example, a processing system, such as processor 602, in conjunction with a storage device, such as memory 606, as discussed herein. A module for determining whether the language contains any setting of an appointment or event 806 may correspond at least in some aspects to, for example, a processing system, such as processor 602, in conjunction with a storage device, such as memory 606, as discussed herein. A module for setting reminders 808 may correspond at least in some aspects to, for example, a processing system, such as processor 602, in conjunction with a storage device, such as memory 606, as discussed herein.

The functionality of the modules 802-806 of FIG. 8 may be implemented in various ways consistent with the teachings herein. In some designs, the functionality of these modules may be implemented as one or more electrical components. In some designs, the functionality of these modules may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 8, as well as other components and functions described herein, may be implemented using any suitable means. Such means also may be implemented, at least in part, using corresponding structure as taught herein. For example, the components described above in conjunction with the “module for” components of FIG. 8 also may correspond to similarly designated “means for” functionality. Thus, in some aspects one or more of such means may be implemented using one or more of processor components, integrated circuits, or other suitable structure as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a computer-readable medium embodying a method for automatically setting a reminder of the mobile device 600.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of automatically setting a reminder, comprising:
engaging in a communication;
processing and parsing a language used in the communication;
determining whether the language contains any setting of an appointment or event based on the processing and parsing of the language; and
setting the reminder based on the determination that the language contains an appointment or an event.

2. The method of claim 1, further comprising:
sending an alert for the reminder.

3. The method of claim 2, further comprising:
checking for a permission to process and parse the language before processing and parsing the language.

4. The method of claim 3, further comprising:
checking an alert setting, wherein the alert is sent based on the alert setting.

5. The method of claim 1, wherein the processing and parsing of the language is performed by an artificial neural network.

6. The method of claim 4, wherein the alert setting directs how and where the alert is sent.

7. The method of claim 2, wherein the alert comprises a pop up window, a text message, a ringtone, a vibration or a combination thereof

8. The method of claim 5, wherein the alert is sent to a device processing the language or to another device connected to the device processing the language.

9. The method of claim 1, wherein the communication is a verbal communication, a text message, a note, a voice message or a combination thereof

10. An apparatus for automatically setting a reminder, comprising:
means for engaging in a communication;
means for processing and parsing a language used in the communication;
means for determining whether the language contains any setting of an appointment or event based on the processing and parsing of the language; and
means for setting the reminder based on the determination that the language contains an appointment or an event.

11. The apparatus of claim 10, further comprising:
means for sending an alert for the reminder.

12. The apparatus of claim 11, further comprising:
means for checking for a permission to process and parse the language before processing and parsing the language.

13. The apparatus of claim 12 further comprising:
means for checking an alert setting, wherein the alert is sent based on the alert setting.

14. The apparatus of claim 13, wherein the means for processing and parsing of the language is an artificial neural network.

15. The apparatus of claim 14, wherein the alert setting directs how and where the alert is sent.

16. An apparatus for automatically setting a reminder, comprising:
a memory: and
at least one processor coupled to the memory and configured to:
engage in a communication;
process and parse a language used in the communication;
determine whether the language contains any setting of an appointment or event based on the processing and parsing of the language; and
set the reminder based on the determination that the language contains an appointment or an event.

17. The apparatus of claim 16, wherein the at least one processor is further configured to:
send an alert for the reminder.

18. The apparatus of claim 17, wherein the at least one processor is further configured to:
check for a permission to process and parse the language before processing and parsing the language.

19. The apparatus of claim 18, wherein the at least one processor is further configured to:
check an alert setting, wherein the alert is sent based on the alert setting.

20. The apparatus of claim 16, wherein the at least one processor uses an artificial neural network to process and parse the language.

21. The apparatus of claim 19, wherein the alert setting directs how and where the alert is sent.

22. The apparatus of claim 17, wherein the alert comprises a pop up window, a text message, a ringtone, a vibration or a combination thereof.

23. The apparatus of claim 20, wherein the alert is sent to the apparatus or to another device connected to the apparatus.

24. The apparatus of claim 16, wherein the communication is a verbal communication, a text message, a note, a voice message or a combination thereof

25. A computer-readable medium storing computer executable code for automatically setting a reminder, comprising code to:
engage in a communication;
process and parse a language used in the communication;
determine whether the language contains any setting of an appointment or event based on the processing and parsing of the language; and
set the reminder based on the determination that the language contains an appointment or an event.
